(19) United States
(12) Patent Application Publication
(10) Pub. No.: US 2020/0215689 A1
(43) Pub. Date: Jul. 9, 2020

(54) CONTROL DEVICE, CONTROL METHOD, AND PROGRAM

(71) Applicant: SONY CORPORATION, Tokyo (JP)

(72) Inventors: Yudai YUGUCHI, Tokyo (JP); Keisuke MAEDA, Tokyo (JP)

(73) Assignee: SONY CORPORATION, Tokyo (JP)

(21) Appl. No.: 16/648,513

(22) PCT Filed: Jun. 29, 2018
(86) PCT No.: PCT/JP2018/024942

§ 371 Date: Mar. 18, 2020

(30) Foreign Application Priority Data
Sep. 25, 2017 (JP) 2017-183762

(51) Int. Cl. B25J 9/16; G05D 1/00; G05D 1/02

(52) U.S. Cl. CPC B25J 9/1664; B25J 9/1697; G05D 2201/0213; G05D 1/0212; G05D 1/0088

(57) ABSTRACT

There is provided a control device to control the track of a mobile body in accordance with the accuracy of obtained information regarding the external environment, the control device including: a current point calculation unit that calculates a current position of a mobile body; a target point calculation unit that calculates a target position to which the mobile body moves; and a track control unit that controls a track on which the mobile body is caused to move from the current position to the target position on the basis of an external environment recognition accuracy.

### TECHNICAL FIELD

The present disclosure relates to a control device, a control method, and a program.

### BACKGROUND ART

As a method of causing a mobile body such as a robot arm or a self-propelled robot to execute a desired motion, there is a method of giving the mobile body a path from a current position to a target position and a track on which time of passing through coordinates on the path is set, causing the mobile body to follow the track, and thus causing the mobile body to move.

For example, Patent Document 1 described below discloses a technology of causing a vertical articulated arm robot to execute motion along a track by instructing the robot on the movement position and attitude of an arm tip at each passing point of the track. According to the technology disclosed in Patent Document 1, the robot can execute a smoother motion by interpolating the movement position and attitude of the arm tip at a point between passing points of the track given in instruction.

### CITATION LIST

### Patent Document

Patent Document 1: Japanese Patent Application Laid-Open No. 2013-59815

### SUMMARY OF THE INVENTION

### Problems to be Solved by the Invention

With the technology disclosed in Patent Document 1 described above, a mobile body such as a robot is caused to execute motion along a preset track. However, in a case where an external environment of the mobile body has changed, the preset track of the mobile body may not be appropriate. Furthermore, in a case where the external environment of the mobile body is unknown, an appropriate track may not be set for the mobile body.

For this reason, there has been a demand for a technology capable of appropriately controlling the track of a mobile body in accordance with obtained information regarding the external environment.

### Solutions to Problems

According to the present disclosure, there is provided a control device, including: a current point calculation unit that calculates a current position of a mobile body; a target point calculation unit that calculates a target position to which the mobile body moves; and a track control unit that controls a track on which the mobile body is caused to move from the current position to the target position on the basis of an external environment recognition accuracy.

Furthermore, according to the present disclosure, there is provided a control method, including: calculating a current position of a mobile body; calculating a target position to which the mobile body moves, and controlling a track on which the mobile body is caused to move from the current position to the target position on the basis of the external environment recognition accuracy an arithmetic processing unit.

Furthermore, according to the present disclosure, there is provided a program that causes a computer to function as a control device, the control device including: a current point calculation unit that calculates a current position of a mobile body; a target point calculation unit that calculates a target position to which the mobile body moves; and a track control unit that controls a track on which the mobile body is caused to move from the current position to the target position on the basis of the external environment recognition accuracy.

According to the present disclosure, it is possible to appropriately control a direction in which a mobile body enters a vicinity of a target position on the basis of the external environment recognition accuracy.

### Effects of the Invention

As described above, according to the present disclosure, it is possible to appropriately control a track of a mobile body in accordance with obtained information regarding the external environment.

It is to be noted that the above effects are not necessarily restrictive, and any of the effects presented in the present description or other effects that can be understood from the present description may be achieved together with or in place of the above effects.

### BRIEF DESCRIPTION OF DRAWINGS

FIG. 1A is a schematic explanatory view illustrating a mobile body controlled by a technology according to the present disclosure ant a track of the mobile body.

FIG. 1B is a schematic explanatory view illustrating the mobile body controlled by the technology according to the present disclosure and the track of the mobile body.

FIG. 2 is a block diagram illustrating a functional configuration of a control device according to an embodiment of the present disclosure.

FIG. 3 is a graph illustrating control of a track using a cubic Bezier curve.

FIG. 4A is an explanatory view schematically illustrating an example of a track of the mobile body is a case where recognition accuracy of an object is low.

FIG. 4B is an explanatory view schematically illustrating an example of a track of the mobile body in a case where recognition accuracy of an object is high.

FIG. 5 is a flowchart illustrating an example of a flow of control of the control device according to the embodiment.

FIG. 6 is an explanatory view illustrating a first variation of the control device according to the embodiment.

FIG. 7 is an explanatory view illustrating a second variation of the control device according to the embodiment.

FIG. 8 is an explanatory view illustrating a third variation of the control device according to the embodiment.

FIG. 9 is a block diagram illustrating an example of a hardware configuration of the control device according to the embodiment.

### MODE FOR CARRYING OUT THE INVENTION

A preferred embodiment of the present disclosure will hereinafter be described in detail with reference to the accompanying drawings. It is to be noted that in the present description and drawings, components having substantially the same functional configuration are given the same reference numerals, and redundant description thereof will be omitted.

It is to be noted that the description will be given in the following order.

1. Outline

2. Configuration example of control device

3. Control example of control device

4. Variations

5. Hardware configuration example

<1. Outline>

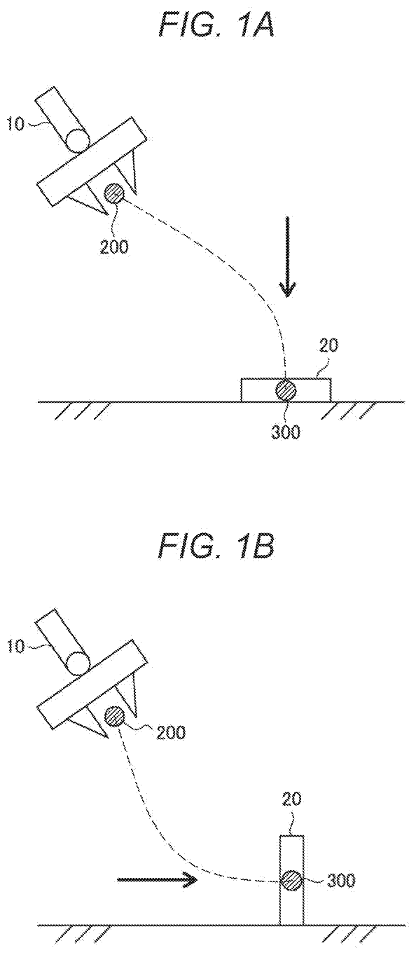

First, an outline of the technology according to the present disclosure will be described with reference to FIGS. 1A and 1B. FIGS. 1A and 1B are schematic explanatory views illustrating a mobile body controlled by the technology according to the present disclosure and a track of the mobile body.

The mobile body in the present embodiment is a machine or device that moves by autonomous or heteronomous control. For example, the mobile body in the present embodiment may be a movable robot such as an autonomous control humanoid robot or a quadruped walking robot, a transportation machine such as an autonomous vehicle or a drone, an arm unit of a mobile or fixed manipulation device, an arm unit of an industrial robot (e.g., an assembly robot for a machine and the like), a service robot (e.g., a medical robot such as a surgical robot, or a cooking robot), or the like, or a robot toy. In the following, a case where the mobile body is an arm unit of a mobile or fixed manipulation device will be mainly described.

As illustrated in FIGS. 1A and 1B, the control device according to the present embodiment controls, as an example, a track of an arm unit (i.e., a mobile body 10) of a manipulation device in a case where the arm unit moves to the vicinity of an object 20 in order to grasp the object 20.

It is to be noted that the object 20 represents an object to be acted upon by the mobile body 10. That is, in the example illustrated in FIGS. 1A and 1B, the object (object 20) is grasped by the arm unit (mobile body 10) of the manipulation device.

Specifically, the control device according to the present embodiment controls a track on which the mobile body 10 is caused to move from a current position 200 of the mobile body 10 to a target position 300 in a vicinity of the object 20. For example, the control device controls a path along which the mobile body 10 passes from the current position 200 to the target position 300, an orientation and attitude of the mobile body 10 when passing through the path, and time when passing through the path.

Here, various paths are conceivable regarding the track on which the mobile body 10 is caused to move from the current position 200 to the target position 300. In a case where the mobile body 10 grasps the object 20, however, it may be appropriate to control the track of the mobile body 10 in consideration of the direction and position in which the mobile body 10 grasps the object 20, depending on the shape of the object 20.

As illustrated in FIG. 1A, for example, in a case where the object 20 has a flat plate shape, it is easier for the mobile body 10 to grasp the object 20 so as to lift the object 20 from a direction perpendicular to a plane on which the object 20 is placed, rather than to grasp the object 20 so as to sandwich the object 20 from a direction parallel to the plane on which the object 20 is placed. As illustrated in FIG. 1B, on the other hand, in a case where the object 20 has a columnar shape, it is easier for the mobile body 10 to grasp the object 20 so as to sandwich the object 20 from a direction parallel to the plane on which the object 20 is placed, rather than to grasp the object 20 so as to lift the object 20 from a direction perpendicular to a plane on which the object 20 is placed.

In this manner, the track of the mobile body 10 grasping the object 20 can be controlled more appropriately by considering the orientation and attitude of the mobile body 10 at the target position 300 (i.e., the grasping attitude of the mobile body 10 based on the shape of the object 20). However, the shape of the object 20 may not be accurately recognized when the mobile body 10 starts moving. In particular, in a case where a sensor that recognizes the shape and the like of the object 20 is mounted on the mobile body 10 and the mobile body 10 and the object 20 are separated from each other at the current position 200, the sensor mounted on the mobile body 10 may not be accurately recognizing the shape of the object 20.

Furthermore, not only in the case described above, in a case where the mobile body 10 is caused to move from the current position 200 to the target position 300, it is important to appropriately control the orientation and attitude of the mobile body 10 entering the target position 300 in consideration of the external situation in the vicinity of the target position 300.

The control device according to the present embodiment has been conceived of by considering the above circumstances and the like. The control device according to the present embodiment is a control device that controls the track of the mobile body 10 on the basis of the external environment recognition accuracy. For example, the control device according to the present embodiment controls the track of the mobile body 10 by reflecting the external environment more in a case where the external environment recognition accuracy is high, and controls the track of the mobile body 10 in consideration of the movement efficiency more in a case where the external environment recognition accuracy is low.

For example, in FIGS. 1A and 1B, in a case where the recognition accuracy of the object 20 is low, the control device may control more linearly the track of the mobile body 10 from the current position 200 to the target position 300. On the other hand, in a case where the recognition accuracy of the object 20 is high, the control device may control the track of the mobile body 10 so that the orientation and attitude of the mobile body 10 in the vicinity of the target position 300 become appropriate for grasping the object 20.

Thus, the control device according to the present embodiment can control the track of the mobile body 10 in accordance with the external environment in a case where information regarding the external environment is appropriately obtained. Furthermore, the control device can linearly control the track of the mobile body 10 in consideration of the movement efficiency in a case where the information regarding the external environment is not appropriately obtained.

It is to be noted that the control device according to the present embodiment may be provided in the mobile body 10. Alternatively, the control device according to the present embodiment may be provided in a robot having the mobile body 10 as a part of the configuration, or may be provided in an information processing server or the like connected with the mobile body 10 via a network. The control device according to the present embodiment may be provided in any device as long as the mobile body 10 can be controlled.

<2. Configuration Example of Control Device>

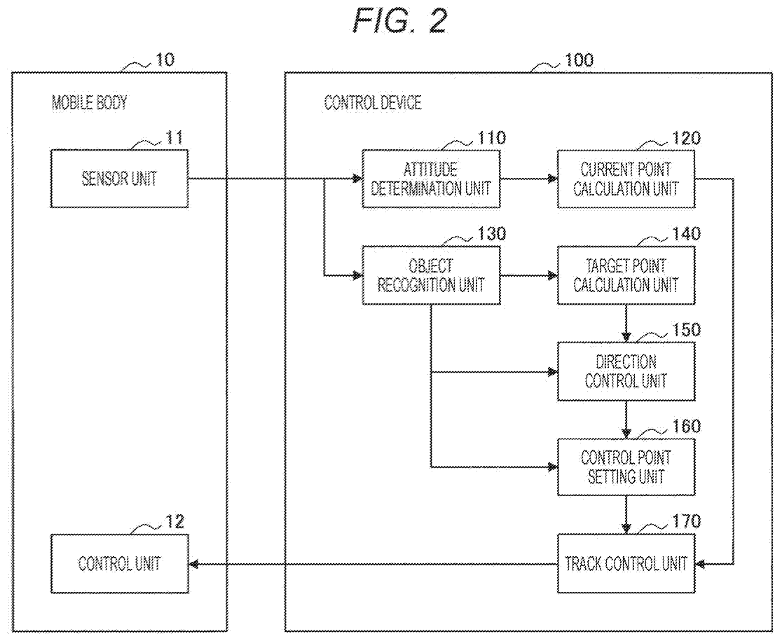

Next, the functional configuration of the control device according to the present embodiment will be described with reference to FIGS. 2 to 4B. FIG. 2 is a block diagram illustrating the functional configuration of a control device 100 according to the present embodiment. Hereinafter, the control device 100 will be described as being provided separately from the mobile body 10.

(Mobile Body 10)

The mobile body 10 is a machine or device that moves by autonomous or heteronomous control as mentioned earlier. For example, the mobile body 10 may be an arm unit of a mobile or fixed manipulation device. As illustrated in FIG. 2, the mobile body 10 includes, for example, a sensor unit 11 and a control unit 12.

The sensor unit 11 is a variety of sensors provided in the mobile body 10. Specifically, the sensor unit 11 includes a sensor that acquires information regarding the external environment in the vicinity of the target position 300 and a sensor that acquires information for determining the current position 200 of the mobile body 10.

The sensor that acquires information regarding the external environment in the vicinity of the target position 300 may be, for example, an imaging device, an atmospheric pressure sensor, a temperature sensor, an illuminance sensor, a microphone, or a millimeter-wave, microwave radar, or the like. The sensor that acquires information regarding the external environment in the vicinity of the target position 300 may be, in particular, an imaging device. The sensor that acquires information for determining the current position 200 of the mobile body 10 may be, for example, a sensor that acquires position information of the mobile body 10, such as a geomagnetic sensor or a global navigation satellite system (GNSS) sensor, or may be a sensor that acquires attitude information of the mobile body 10, such as a rotary encoder, a linear encoder, an acceleration sensor, a gyro sensor, or an imaging device. The sensor that acquires information for determining the current position 200 of the mobile body 10 may be, in particular, a rotary encoder, a linear encoder, or an imaging device. It is to be noted that the imaging device as a sensor that acquires information regarding the external environment in the vicinity of the target position 300 is an imaging device that captures an image of the vicinity of the target position 300. On the other hand, the imaging device as a sensor that acquires information for determining the current position 200 of the mobile body 10 is an imaging device that captures an image of the mobile body 10 itself.

By controlling the overall mechanism of the mobile body 10, the control unit 12 causes the mobile body 10 to move along the track controlled by the control device 100. Specifically, by controlling the movement and attitude of the mobile body 10, the control unit 12 causes the mobile body 10 to move along the track controlled by the control device 100. For example, in a case where the mobile body 10 is an arm unit of a manipulation device, the control unit 12 causes the arm unit to move along the track by controlling the angle of each joint connecting links constituting the arm unit to each other. Alternatively, in a case where the mobile body 10 is an autonomous vehicle, the control unit 12 causes the autonomous vehicle to move along the track by controlling the engine output and the orientation of each wheel of the autonomous vehicle.

(Control Device 100)

The control device 100 controls the track on which the mobile body 10 is caused to move. As illustrated in FIG. 2, the control device 100 includes, for example, an attitude determination unit 110, a current point calculation unit 120, an object recognition unit 130, a target point calculation unit 140, a direction control unit 150, a control point setting unit 160, and a track control unit 170.

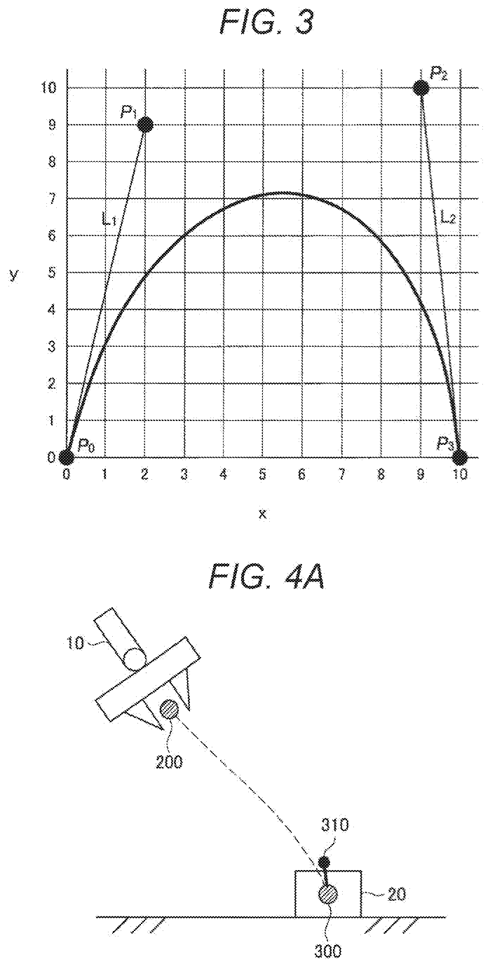

First, a control method for the track of the mobile body 10 by the control device 100 will be described with reference to FIG. 3. The control device 100 may control the track of the mobile body 10 using a cubic Bezier curve, for example. FIG. 3 is a graph illustrating control of a track using a cubic Bezier curve.

As illustrated in FIG. 3, the cubic Bezier curve is a curve having one control point for each of a start point and an end point. In FIG. 3, P₀ is a start point, and P₁ is a control point with respect to the start point. Furthermore, P₃ is an end point, and P₄ is a control point with respect to the end point. At this time, the cubic Bezier curve P(t) defined by P₁ to P₄ can be expressed by the following Formula 1.

[Eq. 1]

P(t)=P₀(1−t)³+3P₁t(1−t)²+3P₂t²(1−t)+P₃t³ (0≤t≤1) Formula 1

As seen from Formula 1 above, various curves can be generated by changing the positions of the control points P₁ and P₂ with the start point P₀ and the end point P₀ of the curve P(t) being fixed. As seen from the graph of FIG. 3, in the cubic Bezier curve, the orientation of the curve P(t) at the start point P₀ coincides with the orientation of a vector P₀P₁, and the orientation of the curve P(t) at the end point P₃ coincides with the orientation of a vector P₃P₂.

Specifically, in the cubic Bezier curve P(t), the degree of coincidence between the orientations of the curve P(t) at the start point P₀ and the end point P₃ and the orientations of the vector P₀P₁ and the vector P₀P₂can be controlled by changing a magnitude L₁ of the vector P₀P₁ and a magnitude L₂ of the vector P₃P₂. For example, the larger the magnitude L₁ of the vector P₀P₁ and the magnitude 12 of the vector P₃P₂ become, the smaller the curvature of the curve P(t) in the vicinity of the start point P₀ and the end point P₃ becomes, and the curve P(t) approaches the vector P₀P₁ and the vector P₀P₂. With this arrangement, in the cubic Bezier curve P(t), the behavior of the curve P(t) in the vicinity of the start point P₀ and the end point P₃ can be controlled by controlling the orientation and magnitude of the vector P₀P₁ and the vector P₃P₂ (i.e., the positions of the control points P₁ and P₂).

Using the cubic Bezier curve having the current position 200 as a start point and the target position 300 as an end point, the control device 100 controls the track of the mobile body 10 by controlling the control points of the start point and the end point of the cubic Bezier curve. Accordingly, the track generated by the control device 100 with the cubic Bezier curve is a curve or a straight line having the current position 200 as a start point and the target position 300 as an end point. With this arrangement, the control device 100 can generate a track on which the movement direction of the mobile body 10 in the vicinity of the current position 200 and the target position 300 is controlled.

It is to be noted that the control device 100 may control the track of the mobile body 10 by using a known curve other than the above-described cubic Bezier curve. For example, in a case of using a quadratic Bezier curve, the control device 100 can control the track of the mobile body 10 more easily than in a case of using a cubic Bezier curve. Furthermore, the control device 100 may control the track of the mobile body 10 using a quartic or higher Bezier curve, a spline curve, a curve obtained by combining the curves described above, or the like.

Next, each configuration of the control device 100 illustrated in FIG. 2 will be described.

Using information acquired by the sensor unit 11 of the mobile body 10, the attitude determination unit 110 determines the attitude of the mobile body 10 on the basis of at least either of kinematics or a captured image. For example, in a case where the mobile body 10 is an arm unit of a manipulation device, the attitude determination unit 110 can determine the position and attitude (orientation) of the tip of the arm unit by performing calculation using the length of each link constituting the arm unit and the angle of each joint connecting the links to each other (also referred to as kinematics). Alternatively, the attitude determination unit 110 may determine the position and attitude (orientation) of the mobile body 10 on the basis of a captured image of the mobile body 10 itself captured by the imaging device provided in the mobile body 10. Furthermore, the attitude determination unit 110 may determine the position and attitude (orientation) of the mobile body 10 by correcting, on the basis of the captured image of the mobile body 10 itself, the position and attitude (orientation) of the mobile body 10 calculated using the kinematics described above.

The current point calculation unit 120 calculates the current position 200 on the basis of the position and attitude of the mobile body 10 determined by the attitude determination unit 110. The current position 200 calculated by the current point calculation unit 120 serves as the start point of the track controlled by the track control unit 170 in a subsequent stage. Specifically, the current point calculation unit 120 may calculate, as the current position 200 that is the start point of the track, the gravity center point or the center point of the mobile body 10 whose position and attitude have been determined by the attitude determination unit 110.

The object recognition unit 130 recognizes the external environment including the object 20 by using information acquired by the sensor unit 11 of the mobile body 10. Specifically, by performing image recognition on a captured image of the external environment including the object 20 captured by the imaging device provided in the mobile body 10, the object recognition unit 130 recognizes which of predetermined categories the object 20 is classified into. For example, the object recognition unit 130 may recognize what the object 20 is by using a machine learning algorithm to classify the object 20 appearing in the captured image.

It is to be noted that the size of the category into which the object 20 is classified may be any size. However, the control device 100 controls the track of the mobile body 10 that exerts an action such as grasping on the object 20. Therefore, the category into which the object 20 is classified is only required to be, for example, a category in which the shape, mass, strength, or the like of the object 20 can be grasped. That is, the category into which the object 20 is classified is only required to have a classification size that makes it recognizable, for example, whether or not the object 20 is a cup, a ball-point pen, a plastic bottle, a mobile phone, a book, or the like.

In addition, the object recognition unit 130 determines the certainty (also referred to as recognition accuracy) of classification for the object 20. For example, the object recognition unit 130 may indicate the certainty of classification of the object 20 by image recognition in percentage corresponding to the accuracy rate of image recognition.

Here, the recognition accuracy of the object 20 by the object recognition unit 130 can vary depending on the amount and accuracy of the external environment information acquired by the sensor unit 11 of the mobile body 10. Specifically, in a case where the object recognition unit 130 recognizes the object 20 by performing image recognition on the captured image as described above, the recognition accuracy of the object 20 can be affected by the sharpness and size of the object 20 appearing in the captured image. For example, in a case where the object 20 appearing in the captured image is small, it is difficult for the object recognition unit 130 to accurately recognize the details of the object 20, and hence the recognition accuracy of the object 20 can be lowered.

For this reason, by determining the recognition accuracy of the object 20, the object recognition unit 130 provides an index for determining how much the object recognition unit 130 considers the classification of the object 20 in the control of the track of the mobile body 10 in the subsequent stage. For example, in a case where the recognition accuracy of the object 20 is low, the classification of the object 20 by the object recognition unit 130 can be considered low in the control of the track of the mobile body 10 in the subsequent stage. In a case where the recognition accuracy of the object 20 is high, on the other hand, the classification of the object 20 by the object recognition unit 130 can be considered high in the control of the track of the mobile body 10 in the subsequent stage.

The database used for classification of the object 20 by the object recognition unit 130 can be a database constructed by a known machine learning algorithm (including any of supervised, unsupervised, and semi-supervised learning), for example. The database used for classification of the object 20 by the object recognition unit 130 may be stored in the control device 100, or may be stored in an external storage device connected with the control device 100 via a network or the like.

It is to be noted that, needless to say, the object recognition unit 130 may recognize the external environment or the object 20 on the basis of information other than a captured image captured by the imaging device provided in the mobile body 10. For example, the object recognition unit 130 may recognize the external environment or the object 20 on the basis of information acquired by the sensor unit 11 provided in the mobile body 10.

The target point calculation unit 140 calculates the target position 300 on the basis of a recognition result of the object 20 by the object recognition unit 130. The target position 300 calculated by the target point calculation unit 140 serves as the end point of the track controlled by the track control unit 170 in the subsequent stage. Specifically, the target point calculation unit 140 may calculate, as the target position 300 serving as the end point of the track, a position where the mobile body 10 can act on the object 20 recognized by the object recognition unit 130. For example, in a case where the mobile body 10 is the arm unit that grasps the object 20, the target point calculation unit 140 may calculate, as the target position 300 serving as the end point of the track of the mobile body 10, a position where the mobile body 10 serving as the arm unit can grasp the object 20.

On the basis of the recognition result of the object 20 by the object recognition unit 130, the direction control unit 150 controls the direction of the track on which the mobile body 10 enters the vicinity of the target position 300. Specifically, on the basis of the recognition result of the object 20, the direction control unit 150 controls the orientation of the vector formed by the target position 300 serving as the end point of the cubic Bezier curve and the control point with respect to the target position 300.

As mentioned earlier, depending on the category of the object 20 classified by the object recognition unit 130, it may be appropriate that the mobile body 10 approaches from a specific direction when acting on the object 20. For example, in a case where the mobile body 10 is the arm unit that grasps the object 20, there may be a direction or attitude of the mobile body 10 that is easy to grasp the object 20, depending on the shape of the object 20. For this reason, the direction control unit 150 controls the orientation of the vector formed by the target position 300 serving as the end point of the track and the control point with respect to the target position 300 such that the mobile body 10 approaches the object 20 from an appropriate direction.

That is, the direction control unit 150 first determines a direction in which the mobile body 10 easily acts on the object 20 on the basis of the recognition result of the object 20 by the object recognition unit 130. Thereafter, the direction control unit 150 controls the orientation of the vector formed by the target position 300 and the control point with respect to the target position 300 such that the mobile body 10 approaches the target position 300 from the determined direction.

It is to be noted that the movement direction of the mobile body 10 in the vicinity of the start point of the track is not particularly limited. For this reason, the direction control unit 150 may or may not control the orientation of the vector formed by the current position 200 serving as the start point of the track and the control point with respect to the current position 200. In a case where the direction control unit 150 does not control the orientation of the vector formed by the current position 200 serving as the start point of the track and the control point with respect to the current position 200, the control point setting unit 160 in the subsequent stage sets the position of the control point with respect to the current position 200 at the position of the current position 200. With this arrangement, the movement direction of the mobile body 10 in the vicinity of the start point is controlled in any direction.

The control point setting unit 160 sets the position of the control point with respect to the target position 300 serving as the end point of the track, on the basis of the recognition accuracy of the object 20 by the object recognition unit 130. Specifically, the control point setting unit 160 first sets the distance between the target position 300 and the control point, on the basis of the recognition accuracy of the object 20 by the object recognition unit 130. Thereafter, the control point setting unit 160 sets the position of the control point with respect to the target position 300, on the basis of the orientation of the vector formed by the target position 300 and the control point controlled by the direction control unit 150 and the distance between the target position 300 and the control point.

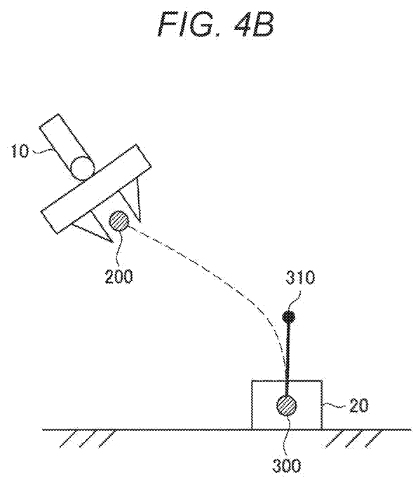

Here, the setting of the distance between the target position 300 and the control point by the control point setting unit 160 will be described more specifically with reference to FIGS. 4A and 4B. FIG. 4A is an explanatory view schematically illustrating an example of a track of the mobile body 10 in a case where the recognition accuracy of the object 20 is low, and FIG. 4B is an explanatory view schematically illustrating an example of the track of the mobile body 10 in a case where the recognition accuracy of the object 20 is high.

For example, in a case where the recognition accuracy of the object 20 is low as illustrated in FIG. 4A, the control point setting unit 160 sets the distance between the target position 300 and a control point 310 to be short (alternatively, the target position 300 and the control point 310 to coincide with each other). By doing so, the control point setting unit 160 controls the track such that the entry direction of the mobile body 10 to the vicinity of the target position 300 controlled by the direction control unit 150 is hardly reflected. In such a case, the track of the mobile body 10 in the vicinity of the target position 300 is close to the straight line connecting the current position 200 and the target position 300.

In a case where the recognition accuracy of the object 20 is low, the recognition of the object 20 is highly likely to be inaccurate, and hence the entry direction of the mobile body 10 to the vicinity of the target position 300 controlled by the direction control unit 150 is highly likely to be inappropriate. In such a case, by shortening the distance between the target position 300 and the control point, the control point setting unit 160 may control the track such that the entry direction of the mobile body 10 to the vicinity of the target position 300 is hardly reflected.

In a case where the recognition accuracy of the object 20 is high as illustrated in FIG. 4B, on the other hand, by setting the distance between the target position 300 and the control point 310 to be long, the control point setting unit 160 controls the track such that the entry direction of the mobile body 10 to the vicinity of the target position 300 controlled by the direction control unit 150 is more reflected.

In a case where the recognition accuracy of the object 20 is high, the recognition of the object 20 is highly likely to be accurate, and hence the entry direction of the mobile body 10 to the vicinity of the target position 300 controlled by the direction control unit 150 is highly likely to be appropriate. In such a case, by lengthening the distance between the target position 300 and the control point, the control point setting unit 160 may control the track such that the entry direction of the mobile body 10 to the vicinity of the target position 300 is reflected.

Here, the control point setting unit 160 may set the distance between the target position 300 and the control point 310 on the basis of a relational expression including the recognition accuracy of the object 20 as a variable, or may set the distance between the target position 300 and the control point 310 to a predetermined value on the basis of whether or not the recognition accuracy of the object 20 has exceeded a threshold value.

However, as described later, in a case where the recognition result for the object 20 is updated by performing image recognition of the object 20 at a predetermined timing (e.g., in real time), the track of the mobile body 10 is recalculated on the basis of the updated recognition result. In such a case, the control point setting unit 160 may set the distance between the target position 300 and the control point 310 on the basis of a relational expression including the recognition accuracy of the object 20 as a variable. This is because the distance between the target position 300 and the control point 310 is continuously changed in a case where the recognition result of the object 20 is updated and the track of the mobile body 10 is recalculated. This allows the control point setting unit 160 to prevent the distance between the target position 300 and the control point 310 from discretely changing due to the update of the recognition result of the object 20, and to prevent the track of the mobile body 10 from rapidly changing.

It is to be noted that in the cubic Bezier curve, the straight line formed by the target position 300 and the control point 310 is an asymptotic line with respect to the track of the mobile body 10, and hence the track of the mobile body 10 does not fully coincide with the vector formed by the target position 300 and the control point 310. In addition, in a case where the distance between the target position 300 and the control point 310 is excessively long, the mobile body 10 approaches the target position 300 by excessively detouring. Accordingly, an upper limit may be provided for the distance between the target position 300 and the control point 310 that is set by the control point setting unit 160.

Using the cubic Bezier curve described earlier, the track control unit 170 controls the track on which the mobile body 10 is caused to move from the current position 200 to the target position 300. Specifically, the track control unit 170 controls the track of the mobile body 10 using the cubic Bezier curve having the current position 200 calculated by the current point calculation unit 120 as a start point, the target position 300 calculated by the target point calculation unit 140 as an end point, and the control point set by the control point setting unit 160 as the control point with respect to the target position 300. This allows the track control unit 170 to generate a track on which the mobile body 10 is caused to approach the target positron 300 in a direction corresponding to the category of the object 20 having been recognized. Furthermore, in a case where the certainty of the category of the object 20 having been recognized is low, the track control unit 170 can generate a track on which the mobile body 10 is caused to more linearly approach the target position 300.

The track control unit 170 may update the track of the mobile body 10 at a predetermined timing (e.g., every 1 millisecond to 100 milliseconds). That is, the track control unit 170 may update the track of the mobile body 10 in real time.

For example, at the current position 200 or the like where the distance between the mobile body 10 and the object 20 is long, the information regarding the external environment or the object 20 acquired by the sensor unit 11 provided in the mobile body 10 is highly likely to be insufficient in terms of accuracy and quantity. In such a case, the recognition accuracy to the external environment or the object 20 by the object recognition unit 130 is highly likely to be low. On the other hand, it is expected that the shorter the distance between the mobile body 10 and the object 20 becomes, the more the accuracy and quantity of the information regarding the external environment or the object 20 acquired by the sensor unit 11 provided in the mobile body 10 will improve. For this reason, the recognition accuracy to the external environment or the object 20 by the object recognition unit 130 is highly likely to increase as the distance between the mobile body 10 and the object 20 becomes shorter.

Then, the control device 100 may update the information regarding the external environment acquired by the sensor unit 11 provided in the mobile body 10 at a predetermined timing, and may update the recognition result of the external environment and the object 20 on the basis of the updated information. This allows the track control unit 170 to recalculate the track of the mobile body 10 in real time and to control the track of the mobile body 10 in real time, on the basis of the updated recognition result of the object 20. Accordingly, the track control unit 170 can control the track of the mobile body 10 such that the mobile body 10 enters the target position 300 along the direction corresponding to the category of the object 20 in accordance with an increase in the certainty of the recognition result of the object 20 by the object recognition unit 130.

According to the configuration described above, the control device 100 according to the present embodiment can control the track of the mobile body 10 on the basis of the external environment recognition accuracy. Specifically, the control device 100 can control the degree of reflecting the direction in which the mobile body 10 approaches the object 20 onto the track of the mobile body 10 on the basis of the recognition accuracy of the object 20.

<3. Control Example of Control Device>

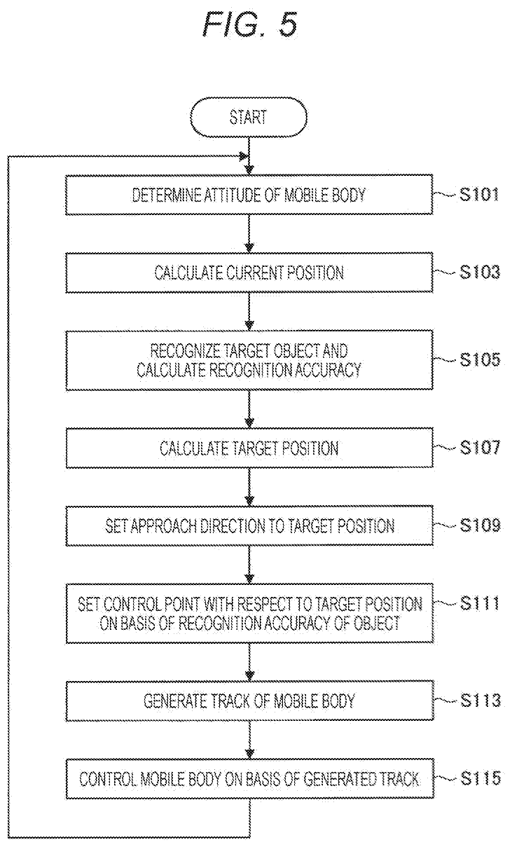

Subsequently, the flow of control of the control device 100 according to the present embodiment will be described with reference to FIG. 5. FIG. 5 is a flowchart illustrating an example of the flow of control of the control device 100 according to the present embodiment.

As illustrated in FIG. 5, the attitude determination unit 110 first determines the position and attitude (orientation) of the mobile body 10 using kinematics or a captured image based on information acquired by the sensor unit 11 provided in the mobile body 10 or the like (S101). Next, the current point calculation unit 120 calculates the current position 200 serving as the start point of the track of the mobile body 10, on the basis of the position and attitude (orientation) of the mobile body 10 having been determined (S103).

On the other hand, the object recognition unit 130 recognizes the object 20 by performing image recognition on an image captured by the imaging device provided in the mobile body 10 or the like. In addition, the object recognition unit 130 calculates the recognition accuracy indicative of the certainty of the recognition result of the object 20 (S105). The recognition accuracy may be, for example, a recognition rate indicative of the certainty of the recognition result of the object 20 in percentage. Next, the target point calculation unit 140 calculates the target position 300 serving as the end point of the track of the mobile body 10 by considering the action of the mobile body 10 on the object 20 having been recognized (S107).

It is to be noted that S101 and S103 as well as S105 and S107 may be executed in an order reverse to the order illustrated in FIG. 5. That is, S101 and S103 may be executed after S105 and S107. Alternatively, S101 and S103 as well as S105 and S107 may be executed in parallel.

Thereafter, the direction control unit 150 sets an approach direction of the mobile body 10 to the target position 300 on the basis of the recognition result of the object 20 by the object recognition unit 130 (S109). Specifically, the direction control unit 150 controls the orientation of the vector formed by the target position 300 and the control point with respect to the target position 300 on the basis of the recognition result of the object 20. Subsequently, the control point setting unit 160 sets the control point with respect to the target position 300 on the basis of the recognition accuracy of the object 20 (S111). Specifically, after setting the distance between the target position 300 and the control point on the basis of the recognition accuracy of the object 20, the control point setting unit 160 sets the position of the control point with respect to the target position 300 on the basis of the distance between the target position 300 and the control point and the orientation of the vector formed by the target position 300 and the control point.

Next, the track control unit 170 generates a track of the mobile body 10 with a cubic Bezier curve using the current position 200, the target position 300, and the control points with respect to the target position 300 that have been calculated in the preceding stage (S113). It is to be noted that the control point with respect to the current position 200 may be set at a position coincident with the current position 200. Subsequently, the control unit 12 of the mobile body 10 controls the motion of the mobile body 10 on the basis of the generated track (115). Thereafter, the control device 100 may control the track of the mobile body 10 in real time by repeating the steps from S101 to S115 at a predetermined timing (e.g., every 1 millisecond to 100 milliseconds).

According to the flow of control described above, the control device 100 according to the present embodiment can control the track of the mobile body 10 in real time in accordance with the recognition accuracy of the object 20 that rises as the mobile body 10 moves towards the target position 300 (i.e., the object 20). Specifically, the control device 100 can control the track of the mobile body 10 such that, as the mobile body 10 moves towards the object 20, the approach direction of the mobile body 10 to the object 20 is along the direction corresponding to the category of the object 20 having been recognized.

<4. Variations>

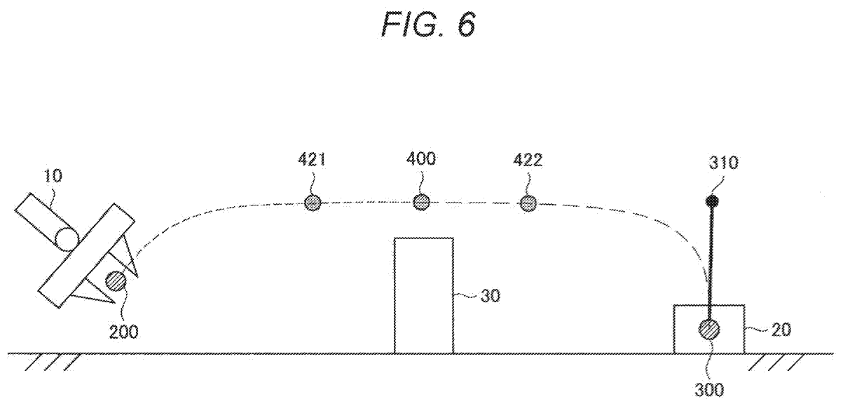

Subsequently, a first to third variations of the control device 100 according to the present embodiment will be described with reference to FIGS. 6 to 8. FIGS. 6 to 8 are explanatory views illustrating the first to third variations of the control device 100 according to the present embodiment.

(First Variation)

First, the first variation of the control device 100 according to the present embodiment will be described with reference to FIG. 6. The first variation is an example in which the track of the mobile body 10 can be controlled in a more complicated manner by providing, between the current position 200 and the target position 300, a via point 400 through which the mobile body 10 passes.

As illustrated in FIG. 6, for example, in a case where an obstacle 30 exists between the current position 200 of the mobile body 10 and the target position 300 in the vicinity of the object 20, the control device 100 may provide the via point 400 between the current position 200 and the target position 300. This allows the control device 100 to cause, by controlling the track of the mobile body 10 so as to pass through the via point 400, the mobile body 10 to move on the track with the obstacle 30 avoided.

Specifically, in a case where the via point 400 is provided between the current position 200 and the target position 300, the control device 100 controls the track using a cubic Bezier curve for every section divided by the via point 400. For example, in the example illustrated in FIG. 6, the control device 100 first controls the track in the section from the current position 200 to the via point 400 by using a cubic Bezier curve having the current position 200 as a start point and the via point 400 as an end point. Furthermore, the control device 100 controls the track in the section from the via point 400 to the target position 300 by using a cubic Bezier curve having the via point 400 as a start point and the target position 300 as an end point. This allows the control device 100 to control the track of the mobile body 10 from the current position 200 to the target position 300 even in a case where the via point 400 is provided.

Here, control points 421 and 422 with respect to the via point 400 are only required to be appropriately set such that the track of the mobile body 10 does not get close to the obstacle 30. However, the control point 421 of the via point 400 in the cubic Bezier curve from the current position 200 to the via point 400 and the control point 422 of the via point 400 in the cubic Bezier curve from the via point 400 to the target position 300 can also be set to be located on the same straight line. In such a case, the cubic Bezier curve from the current position 200 to the via point 400 and the cubic Bezier curve from the via point 400 to the target position 300 can be smoothly connected (smoothed) without having any vertex at the via point 400.

It is to be noted that the control device 100 may provide, between the current position 200 and the target position 300, a plurality of via points 400 through which the mobile body 10 passes. In such a case, the control device 100 can control the track of the mobile body 10 in a further complicated manner.

(Second Variation)

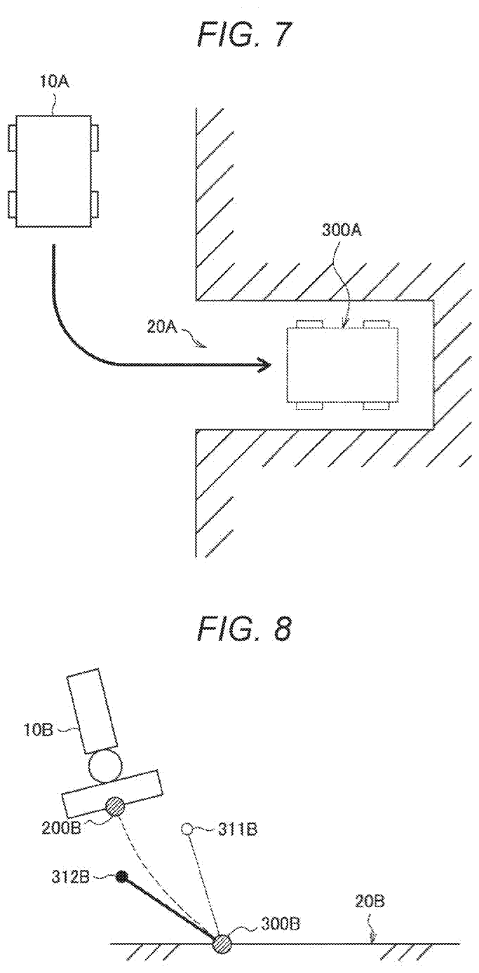

Next, the second variation of the control device 100 according to the present embodiment will be described with reference to FIG. 7. The second variation is an example in which the control device 100 according to the present embodiment is used for track control of transportation equipment such as an autonomous vehicle.

As illustrated in FIG. 7, in the second variation, the control device 100 controls the track on which transportation equipment 10A such as an autonomous vehicle is caused to move to a parking space 20A such as a garage. Accordingly, in the second variation, the transportation equipment 10A corresponds to the mobile body 10, and the parking space 20A corresponds to the object 20. The control device 100 can control the track on which the transportation equipment 10A is caused to move to the parking space 20A by using a cubic Bezier curve having, as a start point, the current position where the transportation equipment 10A exists and having, as an end point, a parking position 300A existing in the parking space 20A. It is to be noted that the control device 100 may control only a movement, path of the transportation equipment 10A, and the attitude of the transportation equipment 10A may be controlled by another control device.

Furthermore, the control device 100 can control the track on which the transportation equipment 10A moves on the basis of information regarding the parking space 20A having been recognized. For example, the control device 100 can recognize the size, the opening width, the depth, the presence of an obstacle, and the like regarding the parking space 20A, and, on the basis of the recognized information, the control device 100 can control the direction of the track when the transportation equipment 10A approaches the parking space 20A. In addition, on the basis of the recognition accuracy of the parking space 20A, the control device 100 can control the degree to which the approach direction to the parking space 20A having been set on the basis of the recognition result of the parking space 20A is reflected onto the track of the transportation equipment 10A. That is, the control device 100 can control the track of the transportation equipment 10A such that the higher the recognition accuracy or the parking space 20A is, the more the recognition result of the parking space 20A is reflected.

(Third Variation)

Subsequently, the third variation of the control device 100 according to the present embodiment will be described with reference to FIG. 8. The third variation is an example in which the control device 100 according to the present embodiment is used for track control when a leg portion of a walking robot or the like is grounded.

As illustrated in FIG. 8, in the third variation, the control device 100 controls a track on which a leg portion 10B of a walking robot or the like is caused to move so as to ground a ground 201B. Accordingly, in the third variation, the leg portion 10B corresponds to the mobile body 10, and the ground 20B corresponds to the object 20. By using a cubic Bezier curve having, as a start point, a current position 200B where the leg portion 10B exists and having, as an end point, a grounding position 300B of the ground 20B, the control device 100 can control the track on which the leg portion 10B of a walking robot or the like is caused to ground the ground 20B.

Furthermore, the control device 100 can control the track on which the leg portion 10B is grounded on the basis of the information regarding the ground 20B having been recognized. For example, the control device 100 can recognize the inclination, undulation, material, friction coefficient, or the like regarding the ground 20B, and, on the basis of the recognized information, the control device 100 can control the direction of the track when the leg portion 10B is grounded to the ground 20B.

For example, in a case where the ground 20B is recognized as slippery, the control device 100 may control the track of the leg portion 10B by setting a control point 311B such that the leg portion 10B approaches the grounding position 300B from a direction along a direction perpendicular to the ground 20B. In a case where the ground 20B is recognized as not slippery, on the other hand, the control device 100 may control the track of the leg portion 10B by setting a control point 312B such that the leg portion 10B approaches the grounding position 300B from a direction along a direction parallel to the ground 20B.

In addition, on the basis of the recognition accuracy of the ground 20B, the control device 100 can control the degree to which the approach direction to the ground 20B having been set on the basis of the recognition result of the ground 20B is reflected onto the track of the leg portion 10B. That is, the control device 100 can control the track of the leg portion 10B such that the higher the recognition accuracy of the ground 20B is, the more the recognition result of the state of the ground 20B is reflected.

<5. Hardware Configuration>

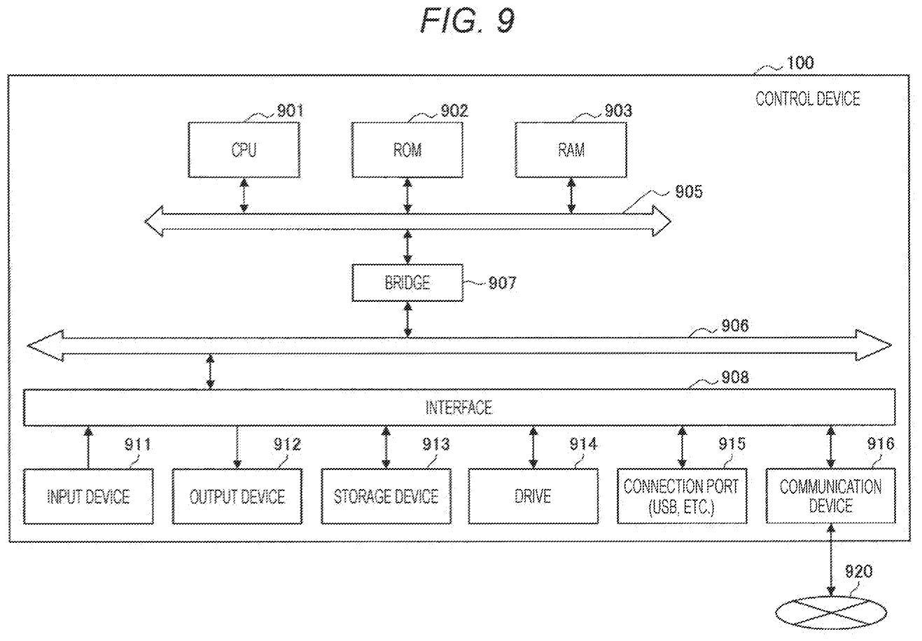

Moreover, a hardware configuration example of the control device 100 according to the present embodiment will be described with reference to FIG. 9. FIG. 9 is a block diagram illustrating an example of the hardware configuration of the control device 100 according to the present embodiment. It is to be noted that information processing by the control device 100 according to the present embodiment is realized by cooperation between software and hardware.

As illustrated in FIG. 9, the control device 100 includes a central processing unit (CPU) 901, a read only memory (ROM) 902, a random access memory (RAM) 903, a bridge 907, internal buses 905 and 906, an interface 908, an input device 911, an output device 912, a storage device 913, a drive 914, a connection port 915, and a communication device 916.

Functioning as an arithmetic processing unit or a control unit, the CPU 901 controls the overall operation of the control device 100 in accordance with various programs stored in the ROM 902 or the like. The ROM 902 stores programs and arithmetic parameters used by the CPU 901, and the RAM 903 temporarily stores programs used in execution of the CPU 901 and parameters and the like appropriately changing in the execution. For example, the CPU 901 may execute the functions of the attitude determination unit 110, the current point calculation unit 120, the object recognition unit 130, the target point calculation unit 140, the direction control unit 150, the control point setting unit 160, and the track control unit 170.

The CPU 901, the ROM 902, and the RAM 903 are interconnected by the bridge 907, the internal buses 905 and 906, and the like. Furthermore, the CPU 901, the ROM 902, and the RAM 903 are also connected with the input device 911, the output device 912, the storage device 913, the drive 914, the connection port 915, and the communication device 916 via the interface 908.

The input device 911 includes an input device to which information is input, such as a touchscreen, a keyboard, a mouse, a button, a microphone, a switch, or a lever. Furthermore, the input device 911 also includes an input control circuit for generating an input signal on the basis of information having been input and outputting it to the CPU 901, or the like.

The output device 912 includes, for example, a display device such as a cathode ray tube (CRT) display device, a liquid crystal display device, or an organic electro luminescence (EL) display device. In addition, the output device 912 may include an audio output device such as a speaker or a headphone.

The storage device 913 is a storage device for storing data of the control device 100. The storage device 913 may include a storage medium, a storage device that stores data in the storage medium, a reading device that reads data from the storage medium, and a deletion device that deletes stored data.

The drive 914 is a storage medium reader/writer, and is incorporated in or attached externally to the control device 100. For example, the drive 914 can read information stored in a removable storage medium such as a mounted magnetic disk, optical disk, magneto-optical disk, or semiconductor memory, and can output the information to the RAM 903. Furthermore, the drive 914 can also write information onto a removable storage medium.

The connection port 915 is, for example, a connection interface configured by a connection port for connecting an external connection device, such as a universal serial bus (USB) port, an Ethernet (registered trademark) port, an IEEE 802.11 standard port, or an optical audio terminal. The communication device 916 is a communication interface configured by a communication device or the like for connecting to a network 920, for example. Furthermore, the communication device 916 may be a wired or wireless LAN-compatible communication device or a cable communication device that performs cable communication by wire.

Furthermore, it is also possible to create a computer program for causing hardware such as the CPU, ROM, and RAM incorporated in the control device 100 to achieve functions equivalent to those of the respective configurations of the control device 100 according to the present embodiment. Furthermore, a storage medium in which the computer program is stored is also provided.

While the preferred embodiment of the present disclosure has been described in detail with reference to the accompanying drawings, the technical scope of the present disclosure is not limited to such examples. It is obvious that a person ordinarily skilled in the art of the present disclosure can conceive of various variations or modifications within the scope of the technical described in the claims, and those variations and modifications are also understood to naturally fall within the technical scope of the present disclosure.

For example, while the object 20 or the target position 300 has been described as static and immobile in the above embodiment, the technology according to the present disclosure is not limited to such an example. The technology according to the present disclosure can also be applied in a case where the object 20 or the target position 300 is dynamic and movable. For example, the technology according to the present disclosure can be applied to a case where the dynamic object 20 is grasped by the mobile body 10 such as a robot arm, a case where the movable object 20 is followed by the mobile body 10 such as a wheel-type or walking robot, or the like.

Furthermore, the effects described in the present description are merely illustrative or exemplary and not restrictive. That is, the technology according to the present disclosure can achieve other effects that are apparent to those skilled in the art from the present description, is addition to or in place of the above effects.

It is to be noted that the following configurations also fall within the technical scope of the present disclosure.

(1)

A control device, including:

a current point calculation unit that calculates a current position of a mobile body;

a target point calculation unit that calculates a target position to which the mobile body moves; and

a track control unit that controls a track on which the mobile body is caused to move from the current position to the target position on the basis of an external environment recognition accuracy.

(2)

The control device according to (1) described above, further including a direction setting unit that sets an entry direction of the mobile body to the target position.

(3)

The control device according to (2) described above, in which the track control unit controls curvature of the track on which the mobile body is directed in the entry direction.

(4)

The control device according to (3) described above, in which the track control unit controls the track such that the higher the recognition accuracy is, the smaller the curvature becomes.

(5)

The control device according to (3) or (4) described above, further including:

a control point setting unit that sets a position of a control point with respect to at least the target position, is which

the track control unit controls curvature of the track on the basis of the control point.

(6)

The control device according to any one of (1) to (5) described above, in which the track control unit controls the track using a Bezier curve.

(7)

The control device according to any one of (1) to (6) described above, in which the track is a straight line or a curve.

(8)

The control device according to any one of (1) to (7) described above, in which the external environment recognition accuracy is as identification accuracy of an object to be acted on by the mobile body at the target position.

(9)

The control device according to (8) described above, in which the object is identified by performing image recognition on a captured image of the external environment.

(10)

The control device according to (9) described above, in which the captured image is captured by an imaging device provided in the mobile body.

(11)

The control device according to (9) or (10) described above, in which the image recognition is performed by a machine learning algorithm.

(12)

The control device according to any one of (8) to (11) described above, in which

the mobile body is an arm device, and

the object is an article grasped by the arm device.

(13)

The control device according to any one of (1) to (12) described above, in which the track control unit updates a track of the mobile body on the basis of the external environment recognition accuracy to be updated at a predetermined timing.

(14)

The control device according to any one of (1) to (13) described above, in which

at least one or more via points are provided between the current position and the target position, and

the track control unit controls the track so as to pass through the via points.

(15)

The control device according to (15) described above, in which the track control unit controls the track using a Bezier curve for every section of the track divided by the via points.

(16)

A control method, including:

calculating a current position of a mobile body;

calculating a target position to which the mobile body moves; and

controlling a track on which the mobile body is caused to move from the current position to the target position on the basis of an external environment recognition accuracy by an arithmetic processing unit.

(17)

A program that causes a computer to function as a control device, the control device including:

a current point calculation unit that calculates a current position of a mobile body;

a target point calculation unit that calculates a target position to which the mobile body moves; and

a track control unit that controls a track on which the mobile body is caused to move from the current position to the target position on the basis of an external environment recognition accuracy.

### REFERENCE SIGNS LIST

10 Mobile body
11 Sensor unit
12 Control unit
20 Object
100 Control device
110 Attitude determination unit
120 Current point calculation unit
130 Object recognition unit
140 Target point calculation unit
150 Direction control unit
160 Control point setting unit
170 Track control unit
200 Current position
300 Target position
310 Control point
400 Via point

1. A control device, comprising:
a current point calculation unit that calculates a current position of a mobile body;
a target point calculation unit that calculates a target position to which the mobile body moves; and
a track control unit that controls a track on which the mobile body is caused to move from the current position to the target position on a basis of an external environment recognition accuracy.

2. The control device according to claim 1, further comprising a direction setting unit that sets an entry direction of the mobile body to the target position.

3. The control device according to claim 2, wherein the track control unit controls curvature of the track on which the mobile body is directed in the entry direction.

4. The control device according to claim 3, wherein the track control unit controls the track such that the higher the recognition accuracy is, the smaller the curvature becomes.

5. The control device according to claim 3, further comprising:
a control point setting unit that sets a position of a control point with respect to at least the target position, wherein
the track control unit controls curvature of the track on a basis of the control point.

6. The control device according to claim 1, wherein the track control unit controls the track using a Bezier curve.

7. The control device according to claim 1, wherein the track is a straight line or a curve.

8. The control device according to claim 1, wherein the external environment recognition accuracy is an identification accuracy of an object to be acted on by the mobile body at the target position.

9. The control device according to claim 8, wherein the object is identified by performing image recognition on a captured image of the external environment.

10. The control device according to claim 9, wherein the captured image is captured by an imaging device provided in the mobile body.

11. The control device according to claim. 9, wherein the image recognition is performed by a machine learning algorithm.

12. The control device according to claim 8, wherein
the mobile body is an arm device, and
the object is an article grasped by the arm device.

13. The control device according to claim 1, wherein the track control unit updates a track of the mobile body on a basis of the external environment recognition accuracy to be updated at a predetermined timing.

14. The control device according to claim 1, wherein
at least one or more via points are provided between the current position and the target position, and
the track control unit controls the track so as to pass through the via points.

15. The control device according to claim 14, wherein the track control unit controls the track using a Bezier curve for every section of the track divided by the via points.

16. A control method, comprising:
calculating a current position of a mobile body;
calculating a target position to which the mobile body moves; and
controlling a track on which the mobile body is caused to move from the current position to the target position on a basis of an external environment recognition accuracy by an arithmetic processing unit.

17. A program that causes a computer to function as a control device, the control device comprising:
a current point calculation unit that calculates a current position of a mobile body;
a target point calculation unit that calculates a target position to which the mobile body moves; and
a track control unit that controls a track on which the mobile body is caused to move from the current position to the target position on a basis of an external environment recognition accuracy.
